(19) United States
(12) Patent Application Publication
(10) Pub. No.: US 2026/0307705 A1
(43) Pub. Date: Oct. 8, 2026

(54) CONVERTIBLE STROLLER SYSTEM WITH INTERCHANGEABLE SEAT ASSEMBLIES AND METHOD OF USE

(71) Applicant: Linsey Cicchetto, Berwick, ME (US)

(72) Inventor: Linsey Cicchetto, Berwick, ME (US)

(21) Appl. No.: 19/640,368

(22) Filed: Apr. 6, 2026

Related U.S. Application Data
(60) Provisional application No. 63/784,068, filed on Apr. 5, 2025.

(51) Int. Cl. B62B 7/12; B62B 7/14; B62B 9/10; B62B 9/12

(52) U.S. Cl. CPC B62B 7/12; B62B 7/142; B62B 9/102; B62B 9/12

(57) ABSTRACT

A convertible stroller may include a foldable chassis having a support member configured to selectively receive different child-support modules. In some embodiments, the child-support modules may include a collapsible chair and an exersaucer. The collapsible chair may be supported by the support member and an upper frame portion of the chassis. The exersaucer may be removably mounted on the support member and may include a rotating sling seat. The stroller may include a floor with a rigid support region and interactive foot pads. Netting may be stored within the support member and selectively deployed around at least part of the stroller. A removed module may be stored on a rear portion of the chassis. In some embodiments, the exersaucer may include separable tray portions.

### RELATED APPLICATIONS

This application claims the benefit of U.S. Provisional Application Ser. No. 63/784,068, filed Apr. 5, 2025, entitled Dual-Function Stroller with Fold-Away Seat, Rotating Semi-Standing Seat, and Exersaucer-Style tray, the entire disclosure of which is herein incorporated by reference.

### FIELD OF THE INVENTION

This application relates generally to strollers, and more particularly to combination strollers and exersaucer systems.

### BACKGROUND OF THE INVENTION

Strollers and infant conveyance systems have long served as primary tools for transporting infants and toddlers, and the marketplace has historically segmented such products into distinct, single-purpose categories: standard strollers, jogging strollers, umbrella strollers, travel systems combining a stroller chassis with a removable infant car seat carrier, and tandem or side-by-side double strollers. Each category addresses a specific conveyance use case but is generally not convertible between fundamentally different seating modalities. Conventional stroller chassis employ aluminum or steel frame members connected by pivot joints that collapse the frame into a reduced-footprint configuration for storage and transport. The seat in a conventional foldable stroller is typically either permanently attached to the frame or is removable only for the purpose of installing a compatible infant car seat carrier —not for substituting an entirely different class of seating apparatus. Modular stroller systems have been introduced, such as those permitting reversible seat orientation or accepting a bassinet in lieu of a seated position, or various other convertible strollers converting between stroller, playpen, and folded configurations. However, such modular systems share the common limitation that all interchangeable components are variations of a passive seated, reclined, or lying configuration. None of the prior modular stroller systems accommodate a standing developmental activity center —commonly referred to as an exersaucer —as an interchangeable seat component on the same mobile chassis platform, nor do they provide a mounting platform with purpose-designed coupling features capable of securely receiving both a suspended fabric chair and a rigid exersaucer ring.

Stationary infant activity centers, commonly referred to as exersaucers or activity saucers, are well-established products designed to support infants in a partially weight-bearing standing position while surrounding them with interactive toys and sensory stimuli. Such devices consist of a rigid ring or tray structure supported by a base or legs, with a fabric saddle-style sling seat suspended from the ring that positions the infant's legs through leg openings so the infant can bear partial weight on the floor. Features of prior art exersaucers include rotating seat mechanisms allowing the infant to spin to access toys arranged around the tray perimeter, toys and activity panels integrated into the tray, and height-adjustable bases accommodating infant growth. However, all prior art exersaucers are exclusively stationary floor-standing devices. They are not designed to be mounted on, or integrated with, a mobile stroller chassis. The fundamental limitation of prior art exersaucers is their stationary nature: the infant must be placed in the exersaucer at a fixed location, and the caregiver cannot transport the infant while the infant is in the exersaucer. Conversely, when the infant is in the stroller for transport, the developmental benefits of the exersaucer—weight-bearing standing practice, rotational access to stimuli, and sensory foot engagement —are entirely unavailable. Furthermore, the exersaucer trays of the prior art have been manufactured as unitary rings, precluding the use of only a portion of the tray alongside a conventional seated configuration, and no prior art provides a structural interface for securely mounting a rigid exersaucer ring to a foldable stroller truss such that the exersaucer is stable during transit over uneven terrain.

Protective accessories for strollers—including rain covers, sun canopies, insect netting, and wind shields—are well known in the art. Conventional stroller rain covers and netting are separate accessory items that must be attached to the stroller by the user when needed and removed and stored separately when not in use. They are typically draped over the exterior of the stroller canopy and seat area and secured by elastic edges, snaps, or hook-and-loop fasteners. Such prior art netting and cover solutions share several common limitations: they are separate items that can be lost or forgotten; they must be manually installed and removed, requiring the user to handle a loose and potentially unwieldy fabric article; they do not integrate with the structural members of the stroller frame; and they do not provide a retractable mechanism enabling rapid transition between a fully enclosed protective configuration and an open configuration.

Similarly, interactive infant sensory products, including textured play mats and musical activity gyms, are universally designed as standalone floor mats or as attachments to stationary infant bouncers or play gyms. The prior art does not describe interactive sensory floor pads integrated into the floor of a stroller chassis, nor the combination of such pads with a standing developmental seat mounted on the same mobile platform. Stroller floors are conventionally passive structural elements providing no sensory or developmental function.

In light of these challenges, caregivers of infants and toddlers are required to purchase, transport, store, and manage multiple large products—strollers, exersaucers, activity mats, and rain covers—that serve overlapping developmental periods but cannot be used simultaneously or interchangeably on a common platform. There exists a need for a convertible stroller system that consolidates these functions onto a single chassis, enables rapid interchange between a conventional seated chair configuration and a standing developmental exersaucer, provides deployable protective netting stored within the structural members of the chassis itself, and integrates interactive sensory floor pads beneath the standing seat position, thereby reducing the total product burden on caregivers and extending the useful developmental life of a single chassis investment.

### SUMMARY OF THE INVENTION

In various embodiments, a stroller system may address problems with conventional single-purpose stroller platforms and stationary child activity products. Conventional stroller systems may be limited to seated, reclined, or lying configurations, while stationary activity centers may remain fixed in place and unavailable during transport. A stroller system configured to support different removable child-support modules on a common chassis may reduce the need for separate dedicated platforms for transport and standing activity use.

In some embodiments, a common stroller frame may support selective use of a collapsible chair and an exersaucer on the same support member. The collapsible chair may provide a seated transport configuration. The exersaucer may provide a standing and activity configuration on the mobile stroller platform. A rear storage arrangement may allow a module that is not in active use to remain carried by the stroller, so that a caregiver may reconfigure the stroller at different times without separately transporting the unused module.

In some embodiments, the stroller system may further address limitations associated with separate stroller covers and separate sensory products. Netting and other protectors may be stowed on the stroller and selectively deployed when desired. Interactive foot pads may be provided in a floor region below the exersaucer position. The combination of interchangeable child-support modules, on-board storage, deployable protectors, and floor-based interactive features may provide a more versatile child-support platform on a single chassis.

In an embodiment, a convertible stroller system may include a chassis, a support member including a truss coupled to the chassis, a collapsible chair removably mountable to the truss, and an exersaucer removably mountable to the truss. The collapsible chair and the exersaucer may be interchangeably mountable on the chassis through the truss.

In various embodiments, the truss may be part of a frame of the chassis and may extend between opposite side portions of the chassis. The truss may define a substantially rectangular loop. The truss may include a first side portion extending forward from a first upright post, a front portion extending across a front region of the chassis, and a second side portion extending back toward a second upright post. The collapsible chair may include seat couplings configured to engage the truss and seat back anchors configured to engage an upper handle portion of the chassis. The seat couplings may include front hooks and rear hooks. The truss may include front seat coupling mounts and rear seat coupling mounts configured to receive the front hooks and the rear hooks, respectively. The seat back anchors may include post clips. Each post clip may include an encircling clasp and a peg configured to enter a peg hole in an upright post of the upper handle portion. Each seat coupling may include a tether extending between a hook and a lower seating area of the collapsible chair. The exersaucer may include a channel configured to receive the truss and a latch configured to releasably engage a saucer catch on the truss. The latch may include a pawl, and the saucer catch may include a detent configured to receive the pawl. The exersaucer may include a sling seat supported by a race, and the sling seat may be rotatable relative to the exersaucer. The convertible stroller system may further include a storage pouch and a rear storage arrangement configured to support whichever of the collapsible chair and the exersaucer is not mounted on the truss.

In an embodiment, a method of reconfiguring a convertible stroller system may include removing a first child-support module from a truss of a chassis and mounting a second child-support module to the truss of the chassis. The first child-support module and the second child-support module may be selected from a collapsible chair and an exersaucer.

In various embodiments, mounting the collapsible chair may include engaging seat couplings of the collapsible chair with the truss and engaging seat back anchors with an upper handle portion of the chassis. Engaging the seat couplings may include placing front hooks and rear hooks into front seat coupling mounts and rear seat coupling mounts, respectively. Mounting the exersaucer may include lowering the exersaucer onto the truss so that the truss is received within a channel of the exersaucer, and engaging a latch with a saucer catch on the truss. Removing the exersaucer may include pulling outward on the latch to withdraw a pawl from a detent of the saucer catch. The method may further include storing the first child-support module on a rear portion of the chassis after removing the first child-support module from the truss.

### BRIEF DESCRIPTION OF THE DRAWINGS

The invention description below refers to the accompanying drawings, of which:

FIG. 1 is a perspective view of a convertible stroller with a removable collapsible chair, according to an illustrative embodiment;

FIG. 2 is a front view of the collapsible chair, shown removed from the stroller and ready to be folded or rolled into the storage conformation, according to an illustrative embodiment;

FIG. 3 is a perspective view of a post clip, according to an illustrative embodiment;

FIG. 4 is a perspective view of a stroller chassis without a seat, according to an illustrative embodiment;

FIG. 5 is a rear view of the stroller chassis, showing protectors protecting a lower area, and showing a storage pouch, according to an illustrative embodiment;

FIG. 6 shows a front view of a stroller chassis with a front netting stored within the truss, according to an illustrative embodiment;

FIG. 7 is a side view of the stroller with netting deployed from the truss to the floor, on all sides of the stroller, according to an illustrative embodiment;

FIG. 8 is a perspective view of a stroller with a removable excersaucer, according to an illustrative embodiment;

FIG. 9 is a top view of a stroller with the exersaucer removed to show the interactive foot pads, according to an illustrative embodiment;

FIG. 10 is a schematic diagram of the bottom of an exersaucer, according to an illustrative embodiment;

FIG. 11 is a schematic diagram of a side view of an exersaucer, according to an illustrative embodiment;

FIG. 12 is a rear view of an exersaucer stored on the back of the stroller chassis, according to an illustrative embodiment;

FIG. 13 is a schematic view of an exersaucer with two separable halves, according to an illustrative embodiment; and

FIG. 14 is a rear view of a split exersaucer stored on the back of the stroller chassis, according to an illustrative embodiment.

### DETAILED DESCRIPTION

The present description sets out illustrative embodiments of a convertible stroller system and related methods of use. Various implementations may be used. Features described with respect to one embodiment may be used with other embodiments. Further, the terms and phrases used herein are not intended to be limiting but rather to provide an understandable description of the invention.

In various instances, well-known structures and devices are shown in block diagram form in order to facilitate a description thereof. Various embodiments are discussed hereinafter. It should be noted that the figures are described only to facilitate the description of the embodiments. They are not intended as an exhaustive description and do not limit the scope. Additionally, any particular embodiment need not have all the aspects or advantages described herein. Thus, in various embodiments, any of the features described herein from different embodiments may be combined.

References to one embodiment, an embodiment, another embodiment, one example, or similar phrases indicate that a described feature may be included in at least one embodiment. Such references do not necessarily refer to the same embodiment. Features described for one embodiment may be combined with features of another embodiment. In the following description, related features may be described together for clarity. Combinations of described features may be used in various embodiments.

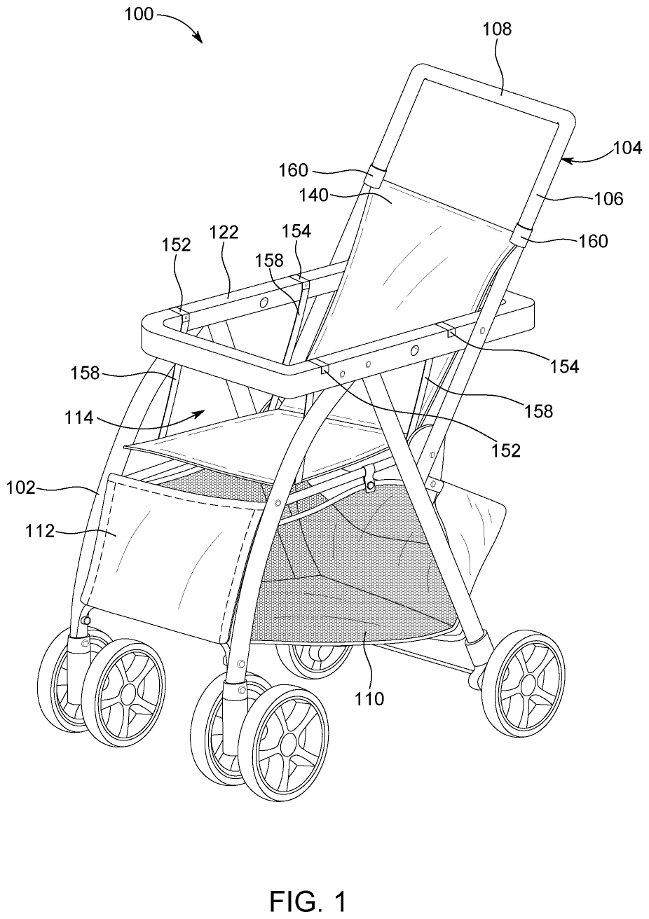

FIG. 1 illustrates a perspective view of a convertible stroller with a removable collapsible chair, according to an illustrative embodiment. The convertible stroller system 100 may include a chassis 102 that may incorporate a seat-supporting truss 122. The chassis 102 and truss 122 may fold to an essentially flat profile suitable for storage in the trunk of an automobile or other compact storage space. The truss 122 may provide a structural interface for multiple interchangeable seat types, as described below. As illustrated in FIG. 1, the stroller 100 may be configured with a collapsible chair 140. The truss 122 and an upper handle portion 104 of the chassis 102 may together define a support frame for the collapsible chair 140. The upper handle portion 104 may be defined as a portion of the chassis 102 extending above the truss 122 and configured to be held by a caregiver while pushing and steering the stroller 100. The upper handle portion 104 may include upright posts 106 and a handle crossbar 108 connecting the upright posts 106.

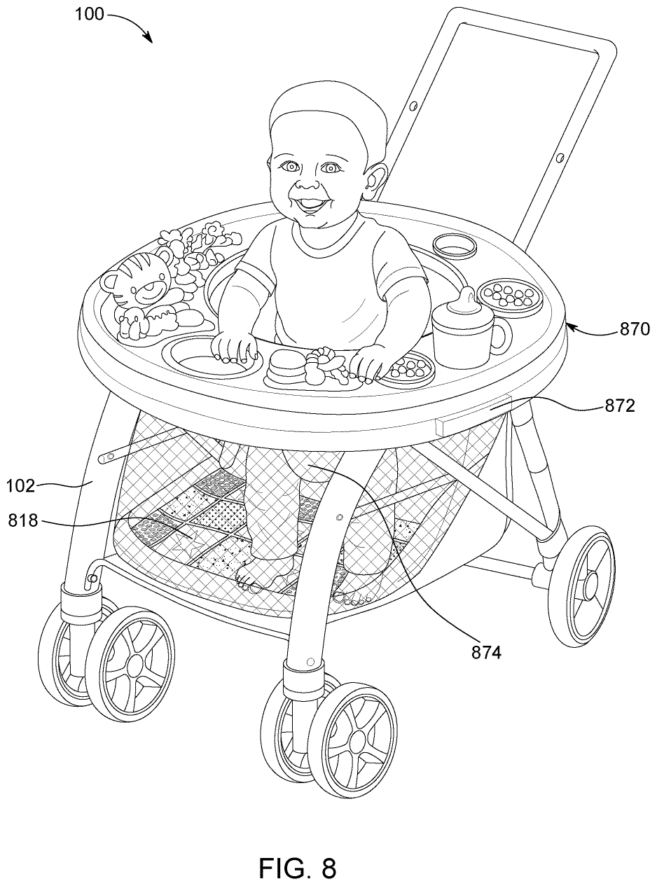

The collapsible chair 140 may be a removable, foldable seat that may be removed from the chassis 102 and stored, and the support frame defined by the truss 122 and upper handle portion 104 may alternatively support a removable exersaucer, as described below with reference to FIGS. 8 through 14. Either seat type may be held to the truss 122 by engagement features adapted for the selected seat type. The truss 122 may include engagement features configured to hold the collapsible chair 140 or the exersaucer. In the chair configuration illustrated in FIG. 1, the collapsible chair 140 may be suspended from the truss 122 by four seat couplings 256. Front seat couplings may include front hooks 152, and rear seat couplings may include rear hooks 154. The front hooks 152 may support a front portion of the collapsible chair 140, and the rear hooks 154 may support a rear portion of the collapsible chair 140 at approximately a location where the chair transitions from the lower seating area 244 upward to the seat back 140. The seat couplings may each include a hook 152, 154 and a tether 158. The hooks 152, 154 may engage corresponding front hook grooves and rear hook grooves formed in a top surface of the truss 122, so that the hooks 152, 154 may remain in a desired location as the stroller 100 moves along an uneven path. A rear portion of the collapsible chair 140 may be further supported by seat back anchors 160 located at upper corners of the seat back. The seat back anchors 160 may clip to the upper handle portion 104 of the chassis 102 and may support the back of the collapsible chair 140. In this manner, the truss 122 and the upper handle portion 104 may together define a support frame for the collapsible chair 140.

The seat back anchors 160 can secure the back of the collapsible chair 140 to the upper handle portion 104 of the stroller 100. In various embodiments, the seat back anchors 160 can secure the seat back to the handle crossbar 108, either directly or through straps or other connectors. In various embodiments, the seat back anchors 160 can connect the seat back to the upright posts 106 of the upper handle portion 104.

In the chair configuration shown in FIG. 1, the front of the stroller 100 can be open, allowing the child's feet to extend outward in front of the stroller. The lower portions of the stroller 100 can be protected with netting 110 and/or panels 112 that can be made from cloth, fabric, water-resistant material, or other materials to block rain and/or sun, depending on the particular panels selected and the desired configuration. Various configurations of removable netting and/or paneling are possible. In various embodiments, a padded cover can be wrapped around the front of the truss 122 using Velcro, straps, or other means, providing protection to a child and preventing the child from contacting the front of the truss 122.

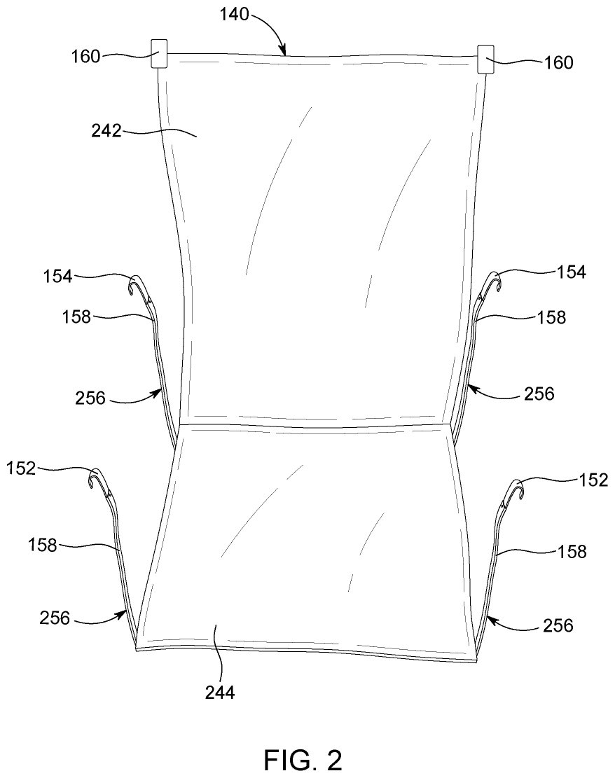

FIG. 2 illustrates a front view of the collapsible chair 140, shown removed from the stroller 100 and ready to be folded or rolled into a storage conformation, according to an illustrative embodiment. The collapsible chair 140 may include a lower seating area 244 and a seat back 242. The lower seating area 244 may be suspended from the truss 122 by the seat couplings 256 when the collapsible chair 140 is installed on the chassis 102. The collapsible chair 140 may include four seat couplings 256 that connect the collapsible chair 140 to the truss 122. Each seat coupling may include a hook 152, 154 and a tether 158. The hooks 152, 154 may hook around the truss 122 and may lock into front hook grooves and rear hook grooves on the top surface of the truss 122. The tethers 158 may extend from the hooks 152, 154 to the lower seating area 244, operatively connecting the lower seating area 244 to the truss 122 above.

The collapsible chair 140 may be suspended from the truss 122 by four J-hooks, including front hooks 152 associated with the front seat couplings and rear hooks 154 associated with the rear seat couplings. In various embodiments, the tethers 158 may be flexible straps that connect the J-hooks to the lower seating area 244. Such a flexible strap configuration may permit the collapsible chair 140 to sway and rock beneath the truss 122 as the stroller 100 travels across uneven ground. In other embodiments, the tethers 158 may be rigid or semi-rigid arms extending from the truss 122 to the lower seating area 244, thereby reducing swaying or movement of the collapsible chair 140 during motion. In a rigid arm embodiment, the J-hooks may lock into the front hook grooves and rear hook grooves of the truss 122 so that the rigid tethers 158 may maintain the collapsible chair 140 in a relatively fixed position compared to a flexible strap embodiment.

The truss 122 and the upper handle portion 104 may together define a support frame 430 for the collapsible chair 140. The seat may be removed from the frame 430, and the seat couplings 256 may be folded inward and laid flat on a surface of the collapsible chair 140. The collapsible chair 140 may then be rolled up for storage within a storage pouch, as described below.

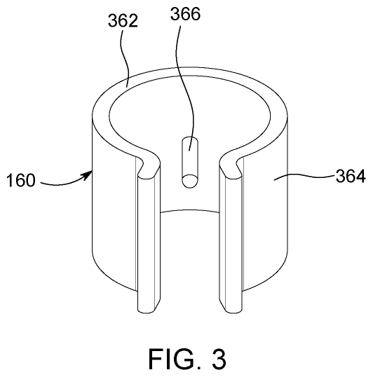

FIG. 3 illustrates a perspective view of a post clip style seat back anchor 160, according to an illustrative embodiment. Various seat back anchor configurations may be used, including anchors that connect to the handle crossbar and/or the upright posts. The seat back anchor 160 may be attached to upper corners of the seat back and may connect the seat back to the upper handle portion of the chassis. In various embodiments, the seat back anchor 160 may include an encircling clasp 362 that may partially encircle the upright post 106 of the upper handle portion, thereby securing the seat back to the upright post 106. The seat back anchor 160 may further include a peg 366 that may fit within a corresponding peg hole formed in the upper handle portion 104. The encircling clasp 362 and the peg 366 may cooperate to maintain the seat back anchor 160 at a selected location on the upper handle portion 104 and may reduce rotational and translational displacement of the seat back anchor 160 relative to the upright post. The peg 366 is illustrated in FIG. 3 as cylindrical, although various peg shapes may be used. In other embodiments, the seat back anchor 160 may have other shapes configured to plug into a corresponding socket or other engagement feature of the upright post.

A user may engage or disengage the seat back anchor 160 from the upper handle portion of the chassis to secure or release the seat back. To install the collapsible chair, the user may insert the peg 366 of each seat back anchor 160 into a corresponding peg hole on the upper handle portion 104 and may snap the encircling clasp 362 around the upright post, thereby securing the seat back to the upper handle portion. To remove the collapsible chair, the user may open the encircling clasp 362 and withdraw the peg 366 from the peg hole, thereby releasing the seat back from the upper handle portion. After releasing the seat back anchors 160, the user may remove the J-hooks from the front hook grooves and rear hook grooves, fold the seat couplings inward onto the seat surface, and roll the collapsible chair into a compact storage form for insertion into the storage pouch.

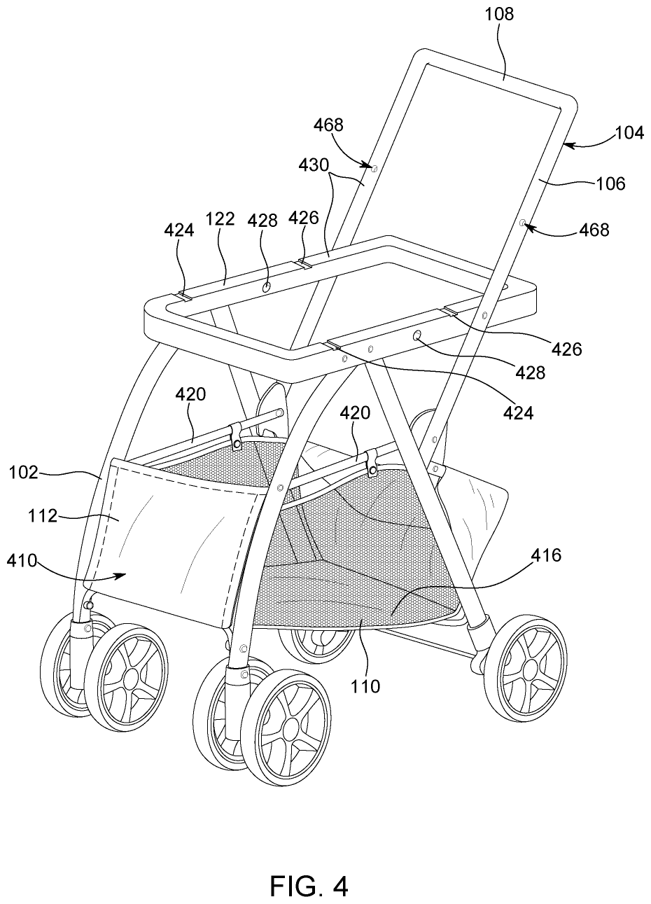

FIG. 4 is a perspective view of the stroller chassis 102 without a seat installed, according to an illustrative embodiment. The upper handle portion 104 includes seatback anchor mounts 468 adapted to engage with the seat back anchors 160. In various embodiments, the seatback anchor mounts 468 can be peg holes formed in the upright posts 106, or various other engagement features adapted to secure a seat back anchor 160 in a fixed position on the upper handle portion 104. The truss 122 can include front seat coupling mounts 424 and rear seat coupling mounts 426 on its top surface. The seat couplings of the collapsible chair can be engaged with the front seat coupling mounts 424 and rear seat coupling mounts 426 of the truss 122, so that the collapsible chair 140 can be suspended below the truss 122 by the tethers. In various embodiments, the front seat coupling mounts 424 and rear seat coupling mounts 426 can be front hook grooves and rear hook grooves, respectively, formed as recesses in the top surface of the truss 122 and adapted to hold the J-hooks of the seat couplings in place against lateral displacement during stroller motion.

The truss 122 can further include saucer catches 428 adapted to engage with the exersaucer and secure the exersaucer in place on the truss 122. The saucer catches 428 may be located on the top or sides of the truss 122 and are adapted to receive latching structures of the exersaucer, as will be described in greater detail below. In various embodiments, the saucer catches 428 may include detents adapted to be engaged by pawls or other latching structures of the exersaucer 870. The stroller 100 can have various adjustable, convertible, or interchangeable protectors 410 below the truss 122. The protectors 410 can include protective netting 110 and/or protective panels 112 that can be made from cloth, fabric, water-resistant material, or other materials to block rain and/or sun, depending on the particular panels selected and the desired configuration. Various configurations of removable netting and/or paneling are possible.

In the chair configuration, the netting and/or paneling can extend from the stroller floor upward to a midway point. The netting can extend from the floor all the way to the truss 122, or can extend only partway up from the floor to a midway point. A lateral bar 420 can be positioned partway between the floor and the truss 122 and can support protectors 410 that protect only the lower portion of the stroller 100. As shown in FIG. 4, the protectors 410 can extend from the floor to the lateral bar 420. The protectors can include netting and/or panels and can be changed depending on user preference. In the chair configuration, the protectors in the front of the stroller 100 can extend partway up from the floor, protecting the lower portion of the stroller, while also leaving an open area 114 at the front that allows a child's feet to extend outward in front of the stroller 100.

In various embodiments, protectors can extend entirely from the truss 122 down to the floor. In various embodiments, the protectors can include multiple protectors that extend from the floor to a midpoint, from the midpoint to the truss 122, and/or from the truss 122 to the floor. In various embodiments, panels can be used instead of, or in addition to, netting. Various possible combinations of protectors are possible, and the user can select and configure the protectors according to the desired level of protection and the prevailing environmental conditions.

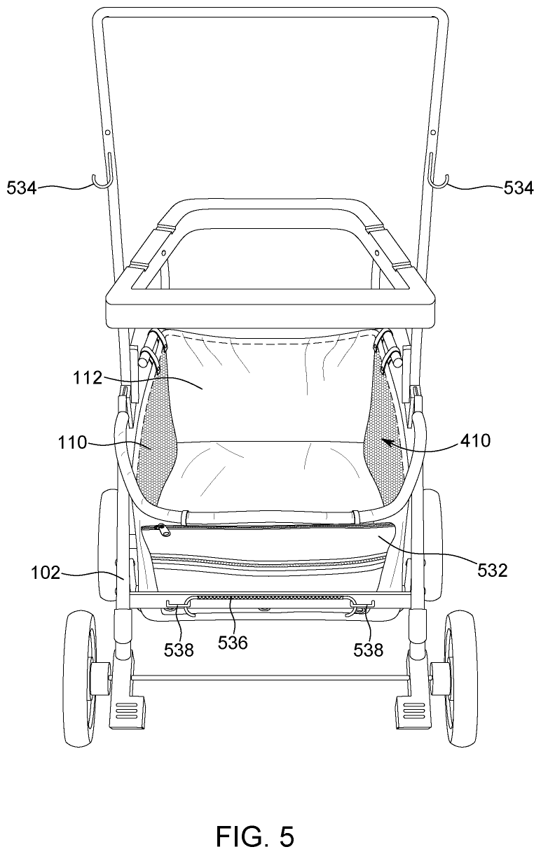

FIG. 5 is a rear view of the stroller chassis 102, showing protectors 110 protecting a lower area of the stroller and showing a storage pouch 532, according to an illustrative embodiment. The storage pouch 532 may be mounted on the rear of the chassis 102 and may be sized and shaped to accommodate the collapsible chair 140 after the collapsible chair 140 has been removed from the chassis 102 and folded or rolled into its compact storage conformation. In the chair configuration, the protectors 110 can protect a lower area of the stroller 100 and can extend from the floor upward to a midpoint partway between the floor and the truss 122. In various embodiments, the protectors 110 may be suspended by the lateral bar 420, or may be connected to other support structures of the chassis 102. A front protector 410 can be a panel 112 of fabric or other water-resistant material configured to prevent splashing inside the stroller 100.

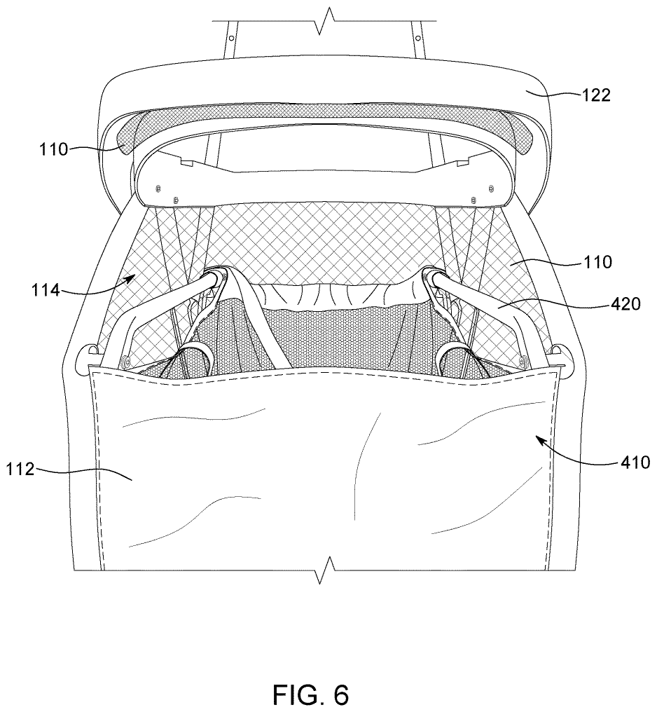

FIG. 6 illustrates a front view of the stroller chassis 102 with netting 110 stored within the truss 122, according to an illustrative embodiment. Netting for a front and/or sides of the stroller 100 may be rolled up and stored within the truss 122. The truss 122 may include an inner channel 622 that may define a hollow interior region configured to receive and retain rolled-up netting 110 when the netting is not deployed. When the stroller 100 is in the chair configuration, the netting 110 at the front of the stroller 100 may be rolled up and stored within the inner channel 622 of the truss 122, thereby creating the open area 114 at the front of the stroller 100 that may allow a child's feet to extend outward. In various embodiments, sections of netting around the sides and/or rear of the stroller 100 may also be rolled up and stored within the inner channel 622 of the truss 122 and deployed downward to create protection for an occupant of the stroller 100. As illustrated in FIG. 6, the rear and side netting may be deployed downward while the front netting may remain rolled up within the inner channel of the truss 122 to maintain the open area for the child's feet. In various embodiments, the netting rolled up and stored within the inner channel 622 of the truss 122 may be held in place by a padded cover wrapped around the front of the truss 122 to protect the child from impact with the truss.

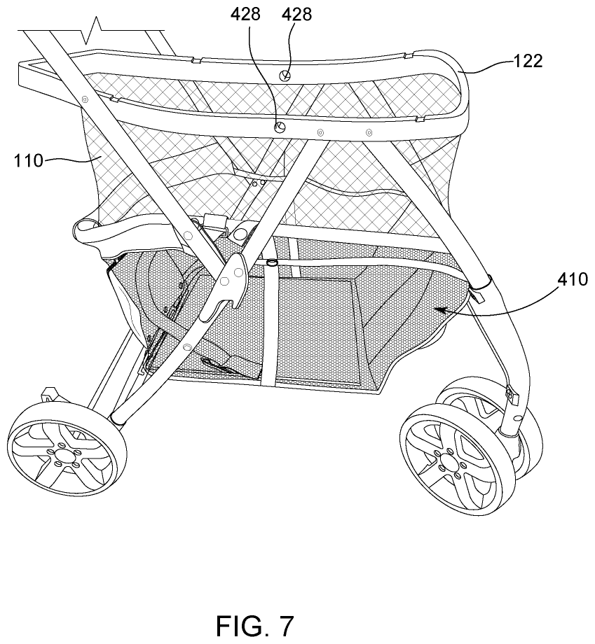

FIG. 7 is a side view of the stroller 100 with netting 110 deployed from the truss 122 to the floor on all sides of the stroller 100, according to an illustrative embodiment. The netting 110 can be deployed from the stored position within the inner channel of the truss 122 to fully encircle the stroller 100, providing protection for the child occupant and preventing toys or other items from being thrown out of or otherwise leaving the confines of the stroller 100. Full deployment of the netting 110 on all sides may be particularly useful when the stroller 100 is configured with the exersaucer, as the child in the standing sling seat configuration may interact vigorously with surrounding toys and the fully deployed netting 110 serves to contain both the child and any play items within the stroller 100. The truss 122 includes saucer catches 428 that may include detents adapted to be engaged by pawls or other latching structures of the exersaucer, as will be described in greater detail below.

FIG. 8 illustrates a perspective view of the stroller 100 with the removable exersaucer 870 installed on the truss, according to an illustrative embodiment. FIG. 8 shows the exersaucer 870 installed on the truss 122 and the interactive foot pads 818. A rigid board embedded within the floor may provide a standing base beneath the interactive foot pads 818, ensuring that the child has a stable surface against which to press their feet. The lateral bar 420 may be positioned partway between the floor and the truss 122 and may support the protectors 410 that protect a lower portion of the stroller 100. The upper handle portion 104 may include the handle crossbar 108 at the top, which may serve as a gripping surface for a caregiver while pushing and steering the stroller 100.

The removable exersaucer 870 may be placed on the truss such that the truss may be received within a channel formed on an underside of the exersaucer 870. A saucer latch 872 of the exersaucer 870 may engage with a saucer catch of the truss to releasably lock the exersaucer 870 in place on the truss. In various embodiments, the saucer catch may be a detent, and the saucer latch 872 may include a pawl. The pawl and the detent may cooperate to latch together and retain the exersaucer 870 on the truss. The exersaucer 870 may include a saddle-style sling seat 874 defining a pair of leg openings and configured to suspend a child in a partially weight-bearing standing position. The exersaucer 870 and the sling seat 874 allow the child to practice standing while being transported in the stroller 100. In various embodiments, the sling seat 874 may rotate within the exersaucer 870, allowing the child to spin in both directions, which may allow access to toys and interactive features arranged around the exersaucer 870.

The floor of the stroller 100 may include a rigid board or other rigid structure embedded within the floor itself, so that a child may stand on a solid, rigid surface. The rigid board within the floor may provide a stable standing base for the child supported in the sling seat 874. In various embodiments, the floor of the stroller 100 may have interactive foot pads 818 arrayed across the floor surface. The interactive foot pads 818 may be arrayed across the floor of the stroller 100 within the region accessible to the child's feet when the child is supported in the sling seat 874 of the exersaucer 870. The interactive foot pads 818 can each generate different sounds and/or have different textures or other tactile characteristics that the child can explore while riding in the exersaucer 870.

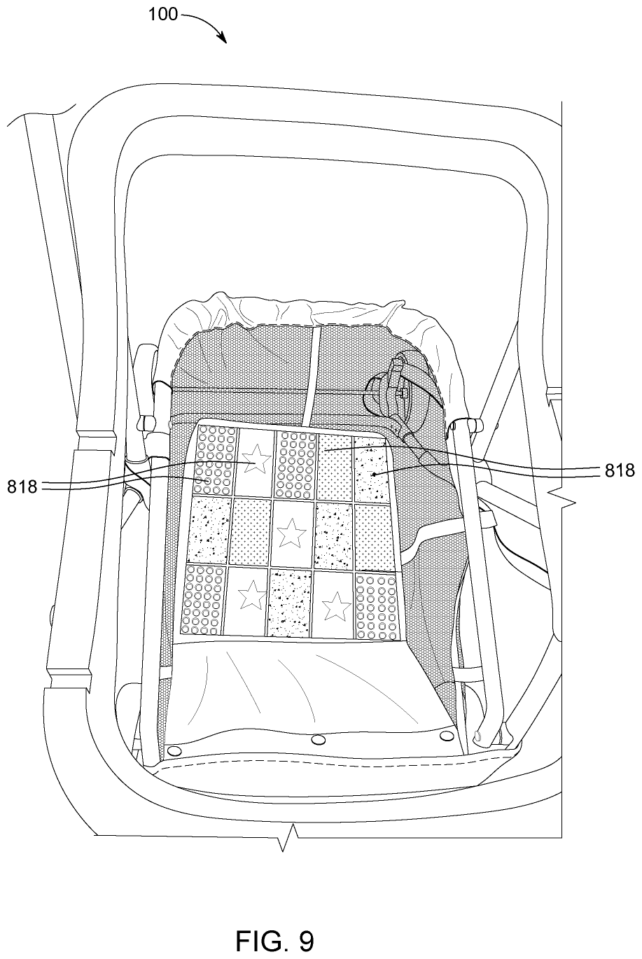

FIG. 9 is a top view of the stroller 100 with the exersaucer removed to show the interactive foot pads 818, according to an illustrative embodiment. The interactive foot pads 818 can have various textures such as raised bumps, furry surfaces, fuzzy surfaces, smooth surfaces, or other tactile surface treatments. The interactive foot pads 818 can have various tactile feels, including gel-filled pads, springy pads, air-filled pads, hard pads, and others. In various embodiments, the interactive foot pads 818 can generate musical tones or other sounds when pressed by the child's feet. As the child presses on different interactive foot pads 818 with their feet, different sounds can be played, with each pad 818 associated with a distinct sound. Each interactive foot pad 818 can play a different sound, providing a variety of different textures and sounds for a child to explore with their feet. In various embodiments, different interactive foot pads 818 can illuminate different lights on the floor and/or on the exersaucer when pressed. The stroller 100 may have one or more switches accessible to the caregiver that can allow the user to turn the sounds and/or lights from the interactive foot pads 818 on or off as desired.

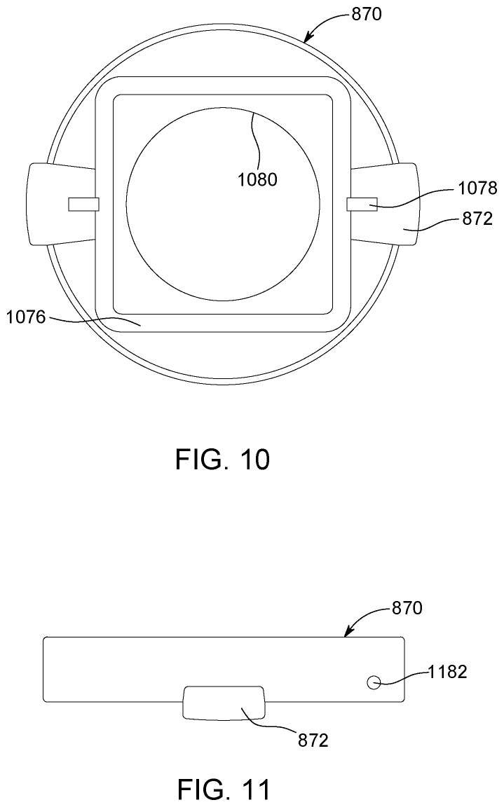

FIG. 10 is a schematic diagram of the underside of the exersaucer 870, according to an illustrative embodiment, and FIG. 11 is a schematic diagram of a side view of the exersaucer 870, according to an illustrative embodiment. The exersaucer 870 may include a channel 1076 on its underside configured to accommodate and engage with the truss 122. The exersaucer 870 can be placed on the truss 122 with the truss 122 received within the channel 1076. The exersaucer 870 has latches 872 on either side of the channel 1076, and each latch 872 may include a pawl 1078 adapted to engage with a corresponding detent of the truss. The user can latch the exersaucer 870 onto the truss by pressing the exersaucer 870 downward until the pawls 1078 snap into the detents of the saucer catches, thereby releasably latching the exersaucer 870 onto the truss. The user can remove the exersaucer 870 by pulling outward on the latches 872 on both sides, thereby withdrawing the pawls 1078 from the detents and releasing the exersaucer 870 from the truss.

The exersaucer 870 may include a race 1080 from which the sling seat 874 may be suspended. The race 1080 may be a rotational bearing structure that allows the sling seat 874 to rotate within the exersaucer 870 while remaining suspended from an exersaucer body. This rotational capability may allow access to toys and interactive features arranged around a perimeter of the exersaucer 870. The exersaucer 870 may have one or more hang points 1182 configured to allow the exersaucer 870 to be suspended from one or more hangers on a rear of the chassis. After the user has removed the exersaucer 870 from the truss, the exersaucer 870 may be hung from the back of the chassis via the hang points 1182.

Turning back to FIG. 5, the stroller chassis 102 can have hangers 534, such as hooks or other mounting hardware, that can be used to suspend the exersaucer 870 on the back of the stroller 100 when the exersaucer 870 is not installed on the truss 122. The stroller chassis 102 can also have a bungee cord and attachment loops, or other means for securing the lower portion of the exersaucer 870 when the exersaucer 870 is stored on the back of the chassis 102. In various embodiments, the attachment loops can be located at multiple positions on the back of the chassis 102, including the lower chassis, a transom on the upper handle portion 104, on the back of the truss 122, and/or other locations, so that the exersaucer 870 can be securely held against the chassis 102 during stroller operation.

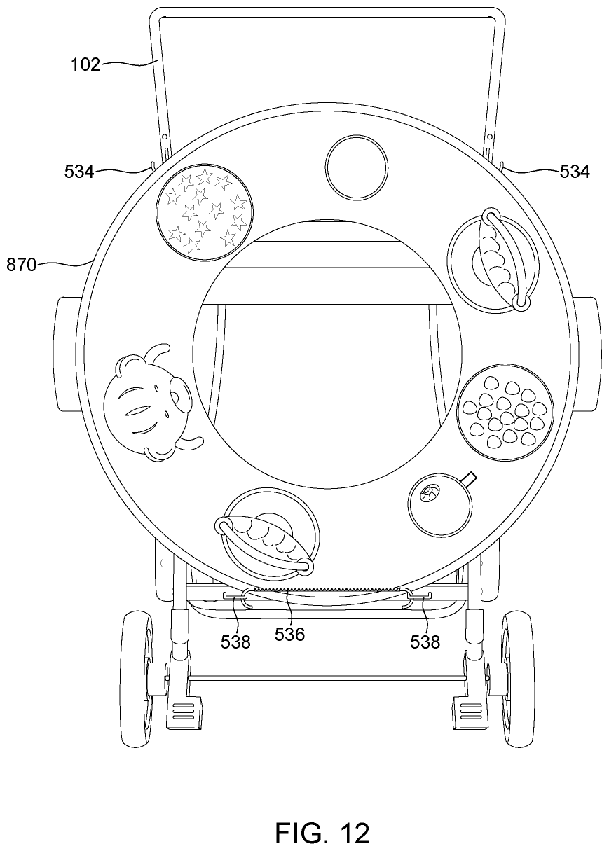

FIG. 12 is a rear view of the exersaucer 870 stored on the back of the stroller chassis 102, according to an illustrative embodiment. The hang points of the exersaucer 870 can be engaged with the hangers 534 on the back of the chassis 102 to suspend the exersaucer 870 from the rear of the stroller 100. Various embodiments of the hang point and hanger interface are possible, including hangers 534 that are hooks on the chassis 102 and hang points that are holes through the exersaucer 870, Velcro straps on the chassis 102 that pass through loops on the exersaucer 870, Velcro straps on the exersaucer 870 that pass through loops on the chassis 102, or various other arrangements of straps, hooks, loops, holes, or other means as will be clear to one of skill in the art. As shown in FIG. 12, the exersaucer 870 may have hang points that are holes, suspended from hangers 534 that are hooks on the chassis 102. A bungee cord, other elastic cord system, Velcro straps, or other means can be used to secure the lower portion of the exersaucer 870 to the chassis 102 when the exersaucer 870 may be stored on the back of the chassis 102, preventing the exersaucer 870 from swinging or bouncing during stroller operation.

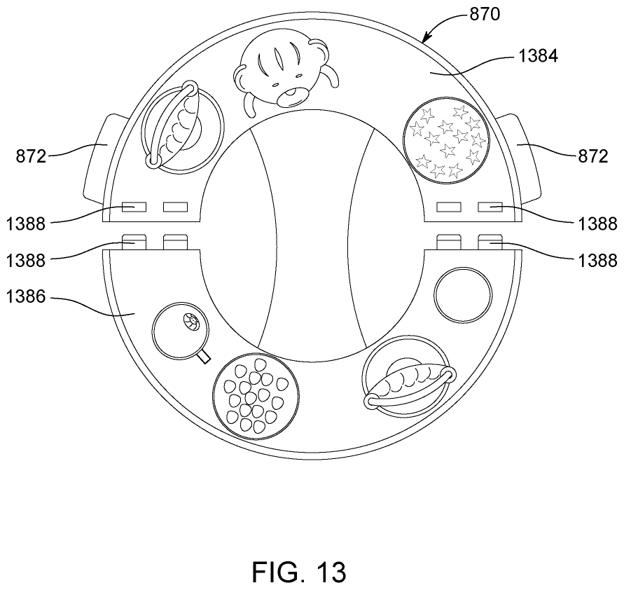

FIG. 13 illustrates a schematic view of an exersaucer 870 with two separable halves, according to an illustrative embodiment. In various embodiments, the exersaucer 870 may be separable into a front tray 1384 and a rear tray 1386. The front tray 1384 and the rear tray 1386 may each have a mating interface 1388, with the mating interfaces 1388 configured to releasably interlock the front tray 1384 and the rear tray 1386 together. The mating interfaces 1388 may include tabs and slots, tongues and grooves, hooks and catches, or other releasable interlocking structures. The separable exersaucer 870 may allow the front tray 1384 to be secured to the truss 122 at the same time as the collapsible chair 140 is installed on the frame 430. In this way, a child may sit in the collapsible chair 140 while also having the front tray 1384 accessible for snacks, toys, or other items.

In various embodiments, the separable exersaucer 870 may be easier to store than a unitary exersaucer. The front tray 1384 and rear tray 1386 can be folded or stacked together to reduce the stored width of the exersaucer 870 when the exersaucer 870 is stored on the back of the chassis 102.

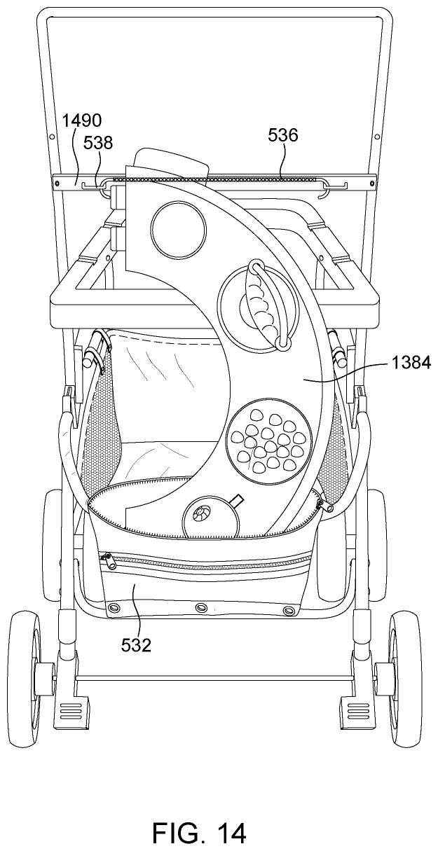

FIG. 14 is a rear view of the split exersaucer 870 stored on the back of the stroller chassis 102, according to an illustrative embodiment. In various embodiments, the separable exersaucer 870 can be stacked together with the front tray 1384 and rear tray 1386 in a stacked configuration, and the lower portion of the stacked exersaucer 870 can be tucked into the storage pouch 532. The storage pouch 532 can support and carry the bottom of the stacked exersaucer 870, providing a stable lower support point while the upper portion of the exersaucer 870 is suspended from the hangers 534. In various embodiments, the chassis 102 can have one or more bungee cord and loop systems configured to secure the exersaucer 870 to the back of the chassis 102. The split exersaucer 870 can be held on the back of the stroller 100 with various combinations of the storage pouch 532, hangers 534, hang points, bungee cords, loops, elastic straps, or other means. In various embodiments, multiple hangers 534, bungee cords, elastic straps, or other means can be located at different positions on the back of the chassis 102, including the lower chassis, a transom 1490 on the upper handle portion 104, on the back of the truss 122, and/or other locations, to provide secure retention of the exersaucer 870 during stroller operation.

In various embodiments, the rear tray 1386 of the exersaucer 870 can be stored on the back of the chassis 102 while the collapsible chair 140 and the front tray 1384 are simultaneously installed on the truss 122 and in use. The front tray 1384 can detach from the rear tray 1386 by disengaging the mating interfaces 1388, and the front tray 1384 can then be installed on the truss 122 alongside the collapsible chair 140 to form a tray surface accessible to the child seated in the collapsible chair 140. Put another way, the split exersaucer configuration allows the stroller 100 to simultaneously provide a seated chair configuration for the child and a tray surface for snacks and toys, without requiring the full exersaucer 870 to be installed on the truss 122.

In operation, a caregiver can configure the stroller in either the collapsible chair configuration or the exersaucer configuration depending on the child's developmental stage and needs. To install the collapsible chair, the caregiver can retrieve the collapsible chair from the storage pouch, unroll or unfold the chair, and unfold the seat couplings outward from the seat surface. The caregiver can then hook the front J-hooks of the front seat couplings into the front hook grooves of the truss and hook the rear J-hooks of the rear seat couplings into the rear hook grooves of the truss. The caregiver can then engage the seat back anchors with the upper handle portion by inserting the pegs into the peg holes and closing the encircling clasps around the upright posts, thereby securing the seat back to the upper handle portion. The caregiver can optionally retract the front netting into the inner channel of the truss to open the front of the stroller for the child's feet, and can deploy the side and rear netting downward from the truss for protection. The caregiver can optionally wrap the padded cover around the front of the truss to protect the child from contact with the truss and to retain the rolled netting within the inner channel.

To transition the stroller from the collapsible chair configuration to the exersaucer configuration, the caregiver can disengage the seat back anchors from the upper handle portion by opening the encircling clasps and withdrawing the pegs from the peg holes. The caregiver can then lift the J-hooks out of the front hook grooves and rear hook grooves, fold the seat couplings inward onto the seat surface, roll or fold the collapsible chair into its compact storage form, and insert the rolled collapsible chair into the storage pouch on the rear of the chassis. The caregiver can then position the exersaucer above the truss and lower it so that the truss is received within the channel on the underside of the exersaucer. The caregiver can press the exersaucer downward until the pawls of the latches snap into the detents of the truss, thereby releasably locking the exersaucer in place on the truss. The caregiver can confirm secure engagement by verifying that the pawl-detent connections on both sides of the exersaucer are fully engaged. The caregiver can optionally deploy the netting on all sides from the truss downward to the floor to fully encircle the stroller 100 and contain the child and any play items within the stroller 100.

To remove the exersaucer from the truss, the caregiver can pull outward on the latches on both sides of the exersaucer, thereby withdrawing the pawls from the detents of the saucer catches and releasing the exersaucer from the truss. The caregiver can then lift the exersaucer off the truss and hang it from the back of the chassis by engaging the hang points of the exersaucer with the hangers on the rear of the chassis. The caregiver can secure the lower portion of the exersaucer to the chassis using bungee cords, elastic straps, Velcro systems, or other means attached to the chassis, thereby preventing the exersaucer from swinging or bouncing during subsequent stroller operation.

To fold the stroller for storage or transport, the caregiver can ensure that no seat is installed on the truss, or that any installed seat is properly secured for folding. The caregiver can then fold the chassis and truss to the essentially flat storage profile. The folded stroller can then be placed in an automobile trunk or other storage location. The compact, essentially flat folded profile of the chassis and truss facilitates convenient storage and transport of the stroller.

Although this invention has been disclosed in the context of certain preferred embodiments and examples, it should be understood by those skilled in the art that the present invention extends beyond the specifically disclosed embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

The foregoing has been a detailed description of illustrative embodiments. Various modifications and additions can be made without departing from the spirit and scope. Features of each of the various embodiments described above may be combined with features of other described embodiments as appropriate in order to provide a multiplicity of feature combinations in associated new embodiments. Furthermore, while the foregoing describes a number of separate embodiments of the apparatus and method, what has been described herein is merely illustrative of the application of the principles of the system described herein. For example, in various embodiments, the tethers of the seat couplings may be adjustable in length to accommodate children of different sizes, or the interactive foot pads may be removable and interchangeable to allow different tactile and auditory configurations. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances (e.g., 1-2%) of the system. Accordingly, this description is meant to be taken only by way of example, and not to otherwise limit the scope of this invention.

What is claimed is:

1. A convertible stroller system comprising:
a chassis;
a support member comprising a truss coupled to the chassis;
a collapsible chair removably mountable to the truss; and
an exersaucer removably mountable to the truss,
wherein the collapsible chair and the exersaucer are interchangeably mountable on the chassis via the truss.

2. The convertible stroller system of claim 1, wherein the truss is part of a frame of the chassis and extends between opposite side portions of the chassis.

3. The convertible stroller system of claim 1, wherein the truss defines a substantially rectangular loop.

4. The convertible stroller system of claim 1, wherein the truss comprises a first side portion extending forward from a first upright post, a front portion extending across a front region of the chassis, and a second side portion extending back toward a second upright post.

5. The convertible stroller system of claim 1, wherein the collapsible chair comprises seat couplings configured to engage the truss and seat back anchors configured to engage an upper handle portion of the chassis.

6. The convertible stroller system of claim 5, wherein the seat couplings comprise front hooks and rear hooks, and the truss comprises front seat coupling mounts and rear seat coupling mounts configured to receive the front hooks and the rear hooks, respectively.

7. The convertible stroller system of claim 5, wherein the seat back anchors comprise post clips, and each post clip comprises an encircling clasp and a peg configured to enter a peg hole in an upright post of the upper handle portion.

8. The convertible stroller system of claim 5, wherein each seat coupling comprises a tether extending between a hook and a lower seating area of the collapsible chair.

9. The convertible stroller system of claim 1, wherein the exersaucer comprises a channel configured to receive the truss and a latch configured to releasably engage a saucer catch on the truss.

10. The convertible stroller system of claim 9, wherein the latch comprises a pawl, and the saucer catch comprises a detent configured to receive the pawl.

11. The convertible stroller system of claim 1, wherein the exersaucer comprises a sling seat supported by a race, and the sling seat is rotatable relative to the exersaucer.

12. The convertible stroller system of claim 1, further comprising a storage pouch and a rear storage arrangement configured to support whichever of the collapsible chair and the exersaucer is not mounted on the truss.

13. A method of reconfiguring a convertible stroller system, the method comprising:
removing a first child-support module from a truss of a chassis; and
mounting a second child-support module to the truss of the chassis,
wherein the first child-support module and the second child-support module are selected from a collapsible chair and an exersaucer.

14. The method of claim 13, wherein mounting the collapsible chair comprises engaging seat couplings of the collapsible chair with the truss and engaging seat back anchors with an upper handle portion of the chassis.

15. The method of claim 14, wherein engaging the seat couplings comprises placing front hooks and rear hooks into front seat coupling mounts and rear seat coupling mounts, respectively.

16. The method of claim 13, wherein mounting the exersaucer comprises lowering the exersaucer onto the truss so that the truss is received within a channel of the exersaucer, and engaging a latch with a saucer catch on the truss.

17. The method of claim 16, wherein removing the exersaucer comprises pulling outward on the latch to withdraw a pawl from a detent of the saucer catch.

18. The method of claim 13, further comprising storing the first child-support module on a rear portion of the chassis after removing the first child-support module from the truss.
